(19) United States
(12) Patent Application Publication
(10) Pub. No.: US 2007/0085845 A1
(43) Pub. Date: Apr. 19, 2007

(54) Display control apparatus, display method, and computer product

(75) Inventors: Fumiko Kikuchi, Tokyo (JP); Hiroshi Toriumi, Tokyo (JP); Naoko Ito, Tokyo (JP); Takayuki Kasuya, Tokyo (JP); Koji Suzuki, Tokyo (JP); Akio Fukushima, Tokyo (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/443,506

(22) Filed: May 31, 2006

(30) Foreign Application Priority Data
Oct. 13, 2005 (JP) 2005-299355

(51) Int. Cl. G09G 5/00

(52) U.S. Cl. 345/204

(57) ABSTRACT

In a display control apparatus, a detecting unit detects a bend in a flexible display having a flex sensor, a determining unit determines, based on detected bend, a command to the flexible display, and a control unit controls the flexible display to display an image of pages being sequentially turned based on the display command.

### BACKGROUND OF THE INVENTION

1. Field of the Invention

The present invention relates to a display control apparatus, a display method, and a computer product with which displayed data is switched by an operation similar to turning a page of an actual book.

2. Description of the Related Art

Electronic books that display text data and image data on an easy-to-carry compact display have become widespread. In such electronic books, improvement in a display quality and operability at the time of making a command to display a desired page is demanded.

Conventionally, to improve operability of an electronic book, a technique in which the electronic book can be operated as an actual book is disclosed. Such a book-type electronic-information browser device includes a page-turning unit provided separately to the display. In the book-type electronic-information browser device, display contents are switched by an operation similar to that in reading an actual book using the page-turning unit (for example, Japanese Patent Application Laid-Open No. H11-312041). An information device for which a flexible substrate having a flex sensor is used as a display (for example, Japanese Patent Laid-Open No. 2001-518185), and in which display contents are switched by bending the display itself has also been disclosed (for example, Japanese Patent Laid-Open No. 2004-318123).

In the book-type electronic-information browser device, however, since the display and the page-turning unit are separately provided, the size of the device increases. Moreover, operating the page-turning unit to switch the display contents is not as pleasing as turning an actual page.

In the information devices disclosed in Japanese Patent Laid-Open Nos. 2001-518185 and 2004-318123, the display contents are switched by bending a portion of the flexible display resembling turning a page an actual book. However, in the information devices, a search function of searching a page an operator wishes to browse is not available. To find the page the operator wishes to browse, the operator is required to find the page while sequentially switching the display contents. This causes both operational and visual load on the operator.

### SUMMARY OF THE INVENTION

It is an object of the present invention to at least solve the above problems in the conventional technologies.

A display control apparatus according to one aspect of the present invention includes a detecting unit configured to detect a bend of a flexible display; a determining unit configured to determine a display command, based on the detected bend; and a control unit configured to control the flexible display to display an image of turning pages sequentially based on the display command.

A display method of a flexible display according to another aspect of the present invention includes detecting a bend of a flexible display; determining a display command, based on detected bend; and controlling the flexible display to display an image of turning pages based on the display command.

A computer-readable recording medium according to still another aspect of the present invention stores therein a computer program for realizing a display method according to the above aspect.

A display control apparatus according to still another aspect of the present invention includes a detecting unit configured to detect a flexure of a flexible display; a determining unit configured to determine whether the flexure has a first pattern; a command generating unit configured to generate a first display control signal to control video data to be displayed on the flexible display. The first display control signal is generated when the determining unit determines that the flexure has the first pattern.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a display control apparatus according to an embodiment of the present invention;

FIG. 2 is a flowchart of a display procedure by the display control apparatus according to the embodiment;

FIG. 3A is a schematic of an electronic book according to the embodiment;

FIG. 3B is a schematic for illustrating a data structure in a display content storing unit;

FIG. 4 is a schematic of a display content of an electronic book;

FIG. 5A is a schematic for illustrating a change in a page-turn operation;

FIG. 5B is a schematic for illustrating the change in the page-turn operation;

FIG. 5C is a schematic for illustrating the change in the page-turn operation;

FIG. 5D is a schematic for illustrating the change in the page-turn operation;

FIG. 5E is a schematic for illustrating the change in the page-turn operation;

FIG. 5F is a schematic for illustrating the change in the page-turn operation;

FIG. 6A is a schematic of an electronic book when power is turned off;

FIG. 6B is a schematic of a display unit when power of the electronic book is switched from OFF back to ON;

FIG. 7A is a schematic for illustrating a bookmark index displayed on the display unit;

FIG. 7B is a schematic for illustrating a chapter index displayed on the display unit;

FIG. 7C is a schematic for illustrating another chapter index displayed on the display unit;

FIG. 8A is a flowchart of a display control; and

FIG. 8B is a flowchart of the display control.

### DETAILED DESCRIPTION OF THE PREFERRED EMBODIMENTS

Exemplary embodiments according to the present invention will be explained in detail below with reference to the accompanying drawings.

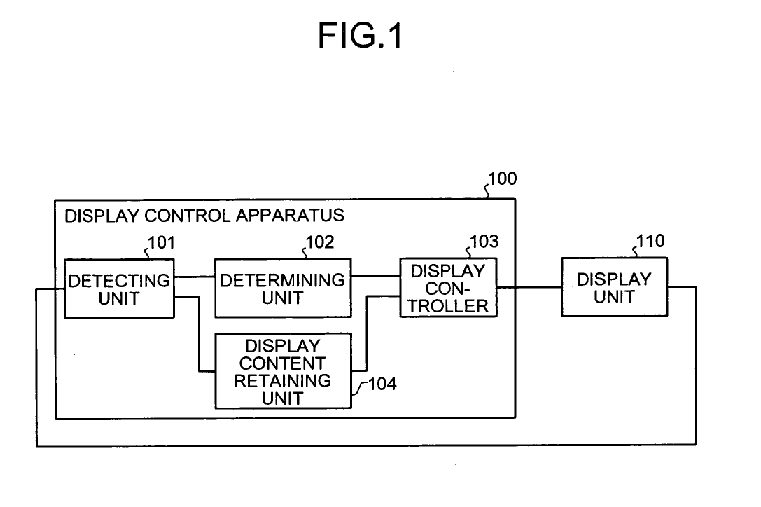

FIG. 1 is a block diagram of a display control apparatus according to an embodiment of the present invention. A display control apparatus 100 includes a detecting unit 101, a determining unit 102, a display controller 103, and a display content retaining unit 104. The detecting unit 101 and the display controller 103 of the display control apparatus 100 are connected to a display unit 110.

The detecting unit 101 detects the bend level of the display unit 110 connected thereto, and outputs a detection result to the determining unit 102 and the display content retaining unit 104. The detecting unit 101 detects, for example, a position of a bend, a direction (inside or outside) of a bend, a degree (frequency) of a bend, and bending speed.

Based on the detected bend level that is input from the detecting unit 101, the determining unit 102 determines a display command made by an operator to the display unit 110 and outputs the command to the display controller 103. The display command includes a command to sequentially display a previous page of a display content, a command to sequentially display a subsequent page of the display content, a command to display indexes, a command to display a display content corresponding to an item in the indexes, a command to mark a page currently being displayed, a command to cancel marking of the page, and a command to stop/restart display.

Basically, when a right edge or the left edge of the display unit 110 is bent, the display content is switched in a direction in which the end is turned. Namely, the display unit 110 is controlled to display an image of pages being turned. When such bend is detected that is caused when the display unit 110 is folded in two at a central part of the display unit 110 so that the display unit 110 faces inside, the display unit 110 is controlled to stop display. When such a bend is detected that the display unit 110 is reopened from a two-folded state, the display unit 110 is controlled to restart the display. By matching the display commands to actions of handling an actual book in this way, the display control apparatus 100 can be easily controlled by an operator. In addition, commands can be set associating with various kinds of bends as necessary depending on an individual.

Based on a determined display command, the display controller 103 controls the display unit 110 to display the display content corresponding to that command. When the display content is switched one page at a time, it appears as if pages are leafed through on the display unit 110. This differs from a scroll screen display in that even if the page is turned at high speed, some of the display contents can be read accurately. The display contents can be confirmed even more speedily if captions are displayed in the left and right side sections. The display contents displayed by the display controller 103 are not limited to electronic books and may be text data including images or image data including multiple pages.

The display content retaining unit 104 retains page data to be displayed on the display unit 110 and bookmark information that has the current display content at the time of detection of bends corresponding to the command to mark a page currently displayed and a command to stop/restart display by the detecting unit 101. The display content retaining unit 104 outputs the bookmark information to the display controller 103.

More specifically, when the detecting unit 101 detects a bend that corresponds to the command to mark a page, the display content retaining unit 104 retains the display content currently being displayed on the display unit 110 as an index item. Information relating to the index that a new item has been added to is output to the display controller 103. If the command is made for a page that has already been marked, the display content retaining unit 104 determines that the command is for canceling the mark, and deletes the item from the indexes retained in the display content retaining unit 104. When the operator makes a command to display the indexes on the display unit 110, following processes by the detecting unit 101 and the determining unit 102, the display controller 103 display the latest index input from the display content retaining unit 104.

When the detecting unit 101 detects the two-folded state of the display unit 110, the display content retaining unit 104 retains the display content currently displayed on the display unit 110. When the detecting unit 101 detects the reopened state of the display unit 110, the display content retaining unit 104 outputs the retained content to the display controller 103. The display controller 103 displays the display content input from the display content retaining unit 104 on the display unit 110.

The display unit 110 includes a flexible display that has a function of outputting a bend level in a numerical value. The output value of the bend level is output to the detecting unit 101. A command relating to the display content is input from the display controller 103, and is displayed on the flexible display based on the input command.

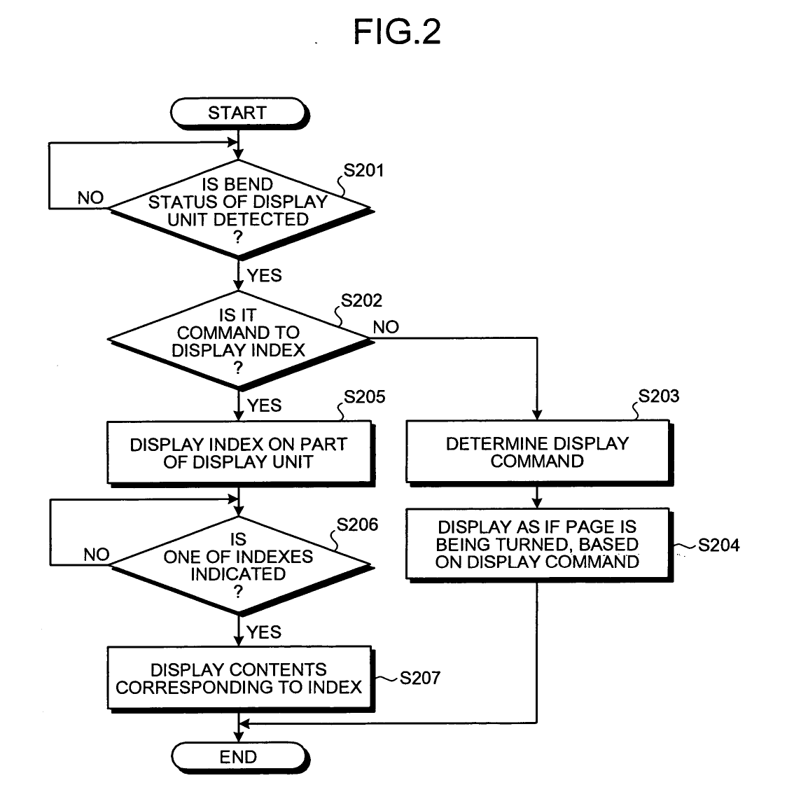

FIG. 2 is a flowchart of a display control procedure by the display control apparatus 100. The display control apparatus 100 determines whether the detecting unit 101 has detected a bend level of the display unit 110 (step S201), and if not, waits by until a bend level is detected (step S201: NO). When a bend level is detected (step S201: YES), the determining unit 102 determines whether the detected bend is an index display command (step S202).

If it is determined that the detected bend is not an index display command (step S202: NO), the determining unit 102 determines a display command based on the detected bend level (step S203). Lastly, the display controller 103 controls the display to display an image of pages being turned based on the display command (step S204). Thus, one series of processing ends.

When the detected bend is an index display command (step S202: YES), the display controller 103 controls to display the index on a portion of the display unit 110 (step S205).

The detecting unit 101 then determines whether an index is specified from among the indexes displayed (step S206), and if not, waits in standby until one of the indexes is specified (step S206: NO). When a command is made for an index (step S206: YES), the display controller 103 controls to display a display content corresponding the specified index is displayed (step S207). Thus, one series of processing ends.

The display unit 110 displays the display content according to a display control by the display controller 103. According to the display content of the display unit 110, the operator operates the display by bending the display unit 110. The bend of the display unit 110 is again detected by the detecting unit 101 of the display control apparatus 100, and the display control process described above is performed.

As described above, according to the display control apparatus 100 of this embodiment, a desired page can be speedily displayed by an operation similar to that for an actual book.

A display control apparatus according to another embodiment of the present invention is incorporated in a flexible display including, for example, a flex sensor, thereby realizing an electronic book that can easily be carried by an operator.

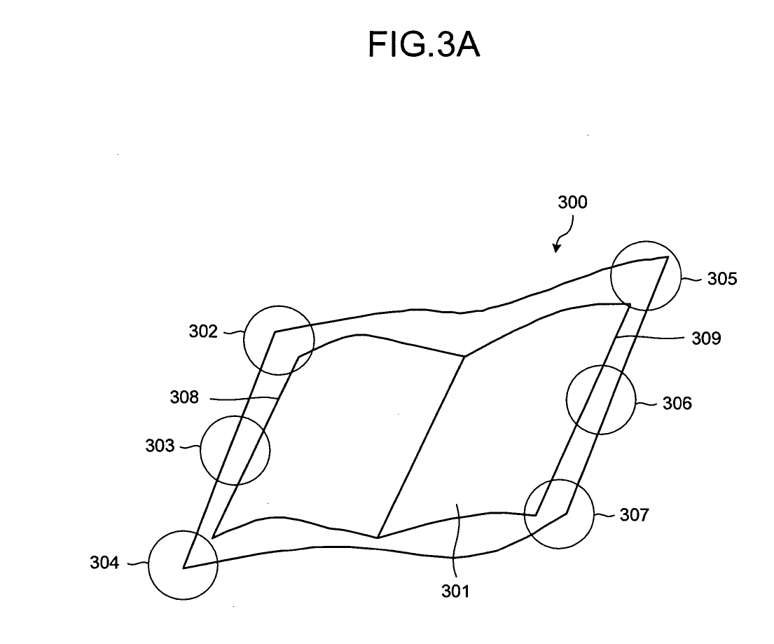

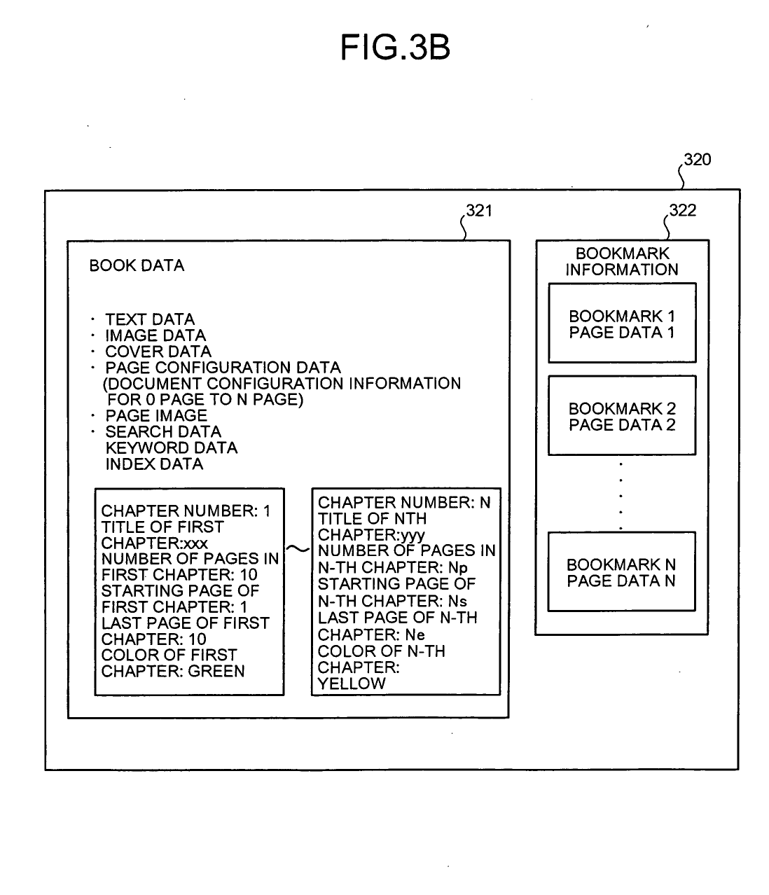

FIG. 3A is a schematic of an electronic book according to this embodiment. An electronic book 300 includes a display unit 301, a left top edge detecting unit 302, a left center edge detecting unit 303, a left bottom edge detecting unit 304, a right top edge detecting unit 305, a right center edge detecting unit 306, a right bottom edge detecting unit 307, a display control apparatus incorporated in the display unit 301, and an electronic book data obtaining unit (these last two are not shown).

The electronic book 300 includes a flexible display. The display unit 301 displays the content of book data obtained by the electronic book data obtaining unit based on display control performed by the display control apparatus. The left top edge detecting unit 302, the left center edge detecting unit 303, the left bottom edge detecting unit 304, the right top edge detecting unit 305, the right center edge detecting unit 306, and the right bottom edge detecting unit 307 include flex sensors, the outputs from the flex sensors of these detecting units 302 to 307 being input to the display control apparatus. The left top edge detecting unit 302, the left center edge detecting unit 303, the left bottom edge detecting unit 304, the right top edge detecting unit 305, the right center edge detecting unit 306, and the right bottom edge detecting unit 307 form parts of the display unit 301, and display contents corresponding to display controls performed by the display control apparatus. The flex sensors of the detecting units 302 to 307 form detecting units.

The detecting units 302 to 307 include flex sensors that use detecting units to detect the bend level when the operator bends the flexible display. However, since flexible displays are generally thin, the flexible displays are likely to be bent even when the operator does not intend to bend. The flexible display is also bent naturally when picked up, leading to a possibility of executing an operation that is not intended by the operator. Therefore, it is preferable that the detecting units 302 to 307 include a touch panel using a capacitance system or the like in addition to the flex sensors on the surface of the display unit 301, and the outputs of the flex sensors are made valid using a determination of whether the operator is touching it as a trigger. This configuration can prevent erroneous operation due to a natural bent or unintended bent caused by a wind or by contacting other objects.

A conventional flex sensor of flexible film is briefly explained (for details, see JP-A No. 2001-518185). A flex sensor detects the bend level of a flexible film (in this embodiment, a flexible display) that the flex sensor itself is attached to. The flex sensor is measured around one or two axes at a right-angle to the long directional dimension of the substrate, according to the properties of that substrate. For example, when using a rope-shaped substrate, a bend has to be sensed directly or indirectly around two axes. The number of sensors required can be reduced by providing a substrate that deforms only within a limited flexibility.

For example, among flex sensors based on optical fiber technology, looped end-type fibers are particularly suitable for sampling the amount of warping at plural positions when the relevant fiber ends are all connected to a plurality of optical fiber source-type photosensor/signal processing units. To measure the bend of a flexible film, the sensitive part of a processed optical fiber can be approximately aligned so as to cut across an axis generated around the bend, such as an axis that expands in a direction intersecting the entire length of a ribbon structure.

Capacitance is also a conventional technique, and is briefly explained. The capacitance system is a position-detecting system in which a glass face of a transparent conductive substrate is coated with a substance for receiving electrical signals, and a sensor is used to detect an electrical signal when a finger of an operator approaches the glass face. In comparison with other systems used in touch panel position detection (for example, infrared light-interception systems and ultrasonic wave/surface elastic wave systems), a capacitance system has an advantage of enabling a highly durable panel to be made easily. Other position-detecting systems include resistance film systems and electromagnetic induction systems. Since their benefits vary according to cost, transmissivity of the panel, and so on, a system can be selected considering how the electronic book is to be used.

The display control apparatus controls the display of book data obtained by the electronic book data obtaining unit based on the output from the flex sensors of the display unit 301.

Explained in further detail, the display control apparatus includes a detecting unit, a determining unit, a display controller, and a display content retaining unit. A basic operation of the apparatus includes use of the detecting unit to detect the bend level of the display unit 301 of the electronic book 300. Based on this detection result, the determining unit determines a display command from the operator. The display content is input to the display controller, and the desired display content is displayed by controlling the display unit 301. When storing a predetermined display content and when adding a predetermined display content to the index after marking it, the display content is stored in the display content retaining unit.

The electronic book data obtaining unit obtains a display content to be displayed on the display unit 301 of the electronic book 300. The display content can be obtained by reading it from a recording medium that the electronic book data is stored in, or by receiving the content from a wired or wireless transmission path. The electronic book data can be arranged in a data format conforming to a predetermined format, or any given data format. When the display control apparatus obtains the-electronic book data in a given data format, it is acceptable to provide software that configures the display content as a one-page layout.

FIG. 3B is a schematic for illustrating a data structure of a display content storing unit. Electronic book data 320 stored in the display content storing unit includes book data 321 and bookmark information 322. The book data 321 includes book data obtained from the electronic book data obtaining unit. While the example of FIG. 3B includes only one type of electronic book data (one book), more than one piece of electronic book data (books) can be stored within the memory capacity of the electronic book 300. In this case, plural sets of data 320 including the book data 321 and the bookmark information 322 will be present.

Book data specifically includes text data, image data, cover data, page configuration data that indicates the configuration of a page for each command relating to a display position on the page or in a layout of texts and images, page image data forming an image such as one scanned from a page of a book, search data such as keywords and an index, and so on. Index data includes, for example, chapter numbers, chapter titles, the number of pages in the chapter, starting pages of chapters, end pages of chapters, chapter headings, and tab color data.

The book data can be data configured for electronic book use beforehand and obtained from the electronic book data obtaining unit, or general text data not intended for display in the electronic book that is obtained and then configured as book data by the display content retaining unit. The bookmark information 322 has page data (page data 1 to page data N) corresponding to bookmark data (bookmark 1 to bookmark N). Unlike the book data 321, the data stored as the bookmark information is accumulated as the operator uses the electronic book. The bookmark information 322 also includes the content of the display page being displayed when the power of the electronic book is turned off. When the power is turned back on, information relating to the display page stored in the bookmark information 322 is read and displayed by the display unit 301.

In this example, the detecting units 302 to 307 of the display unit 301 shown by way of example in FIG. 3A are set to the following display commands.

Left top edge detecting unit 302: When an inward bend (flexure) is detected, mark the display content. When an inward bend (flexure) is detected after marking, cancel marking.

Left center edge detecting unit 303: When an abrupt bend (flipping action) is detected, switch display content to previous page.

Left bottom edge detecting unit 304: When an inward bend (flexure) is detected, switch display content to previous page.

Right top edge detecting unit 305: When an inward bend (flexure) is detected, mark the display content. When an inward bend (flexure) is detected after marking, cancel marking.

Right center edge detecting unit 306: When an abrupt bend (flipping action) is detected, switch display content to subsequent page.

Right bottom edge detecting unit 307: When an inward bend (flexure) is detected, switch display content to subsequent page.

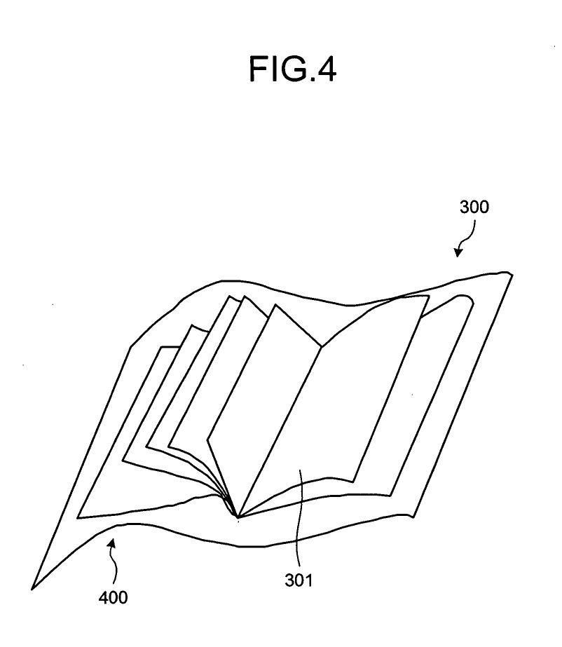

FIG. 4 is a schematic of a display content of an electronic book. When a command to switch the display content is made by an operation such as that described in FIG. 3A, the display content is switched such that the page appears to be turned. The display of the page-turn speed changes according to the bend level such as a curvature 400. This example is set such that the greater the bend level is, the faster the page-turn speed is, and the smaller the bend level is, the slower the page-turn speed is.

When the display content displayed on the display unit 301 is turned one page, the boundary line between the currently displayed page and the subsequently displayed page (the ear part of an actual book) moves leftward from a right page edge 309 until it reaches the position of a left page edge 308, thereby switching to the next page, i.e., turning the page. The display contents on the left and right of the boundary line change depending on where in the display unit 301 the boundary line is located.

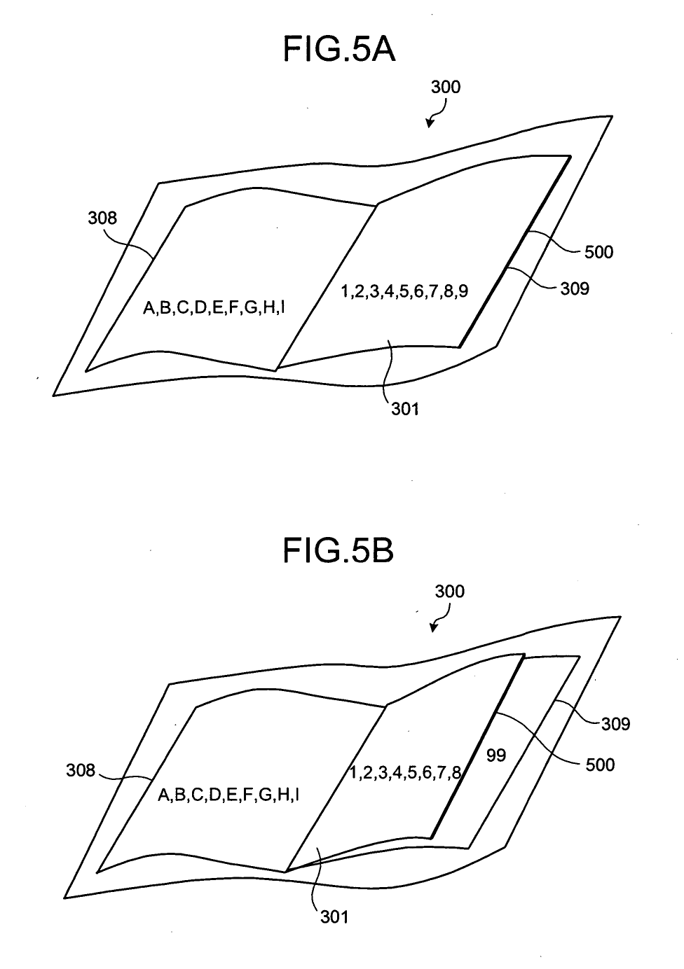

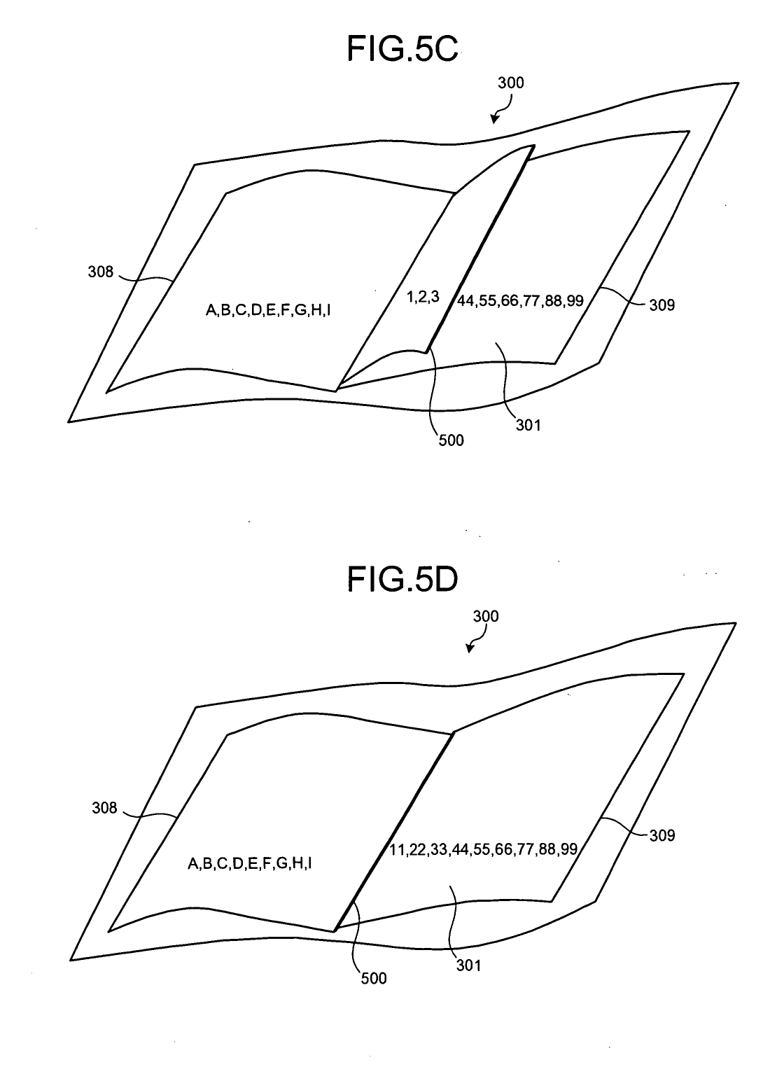

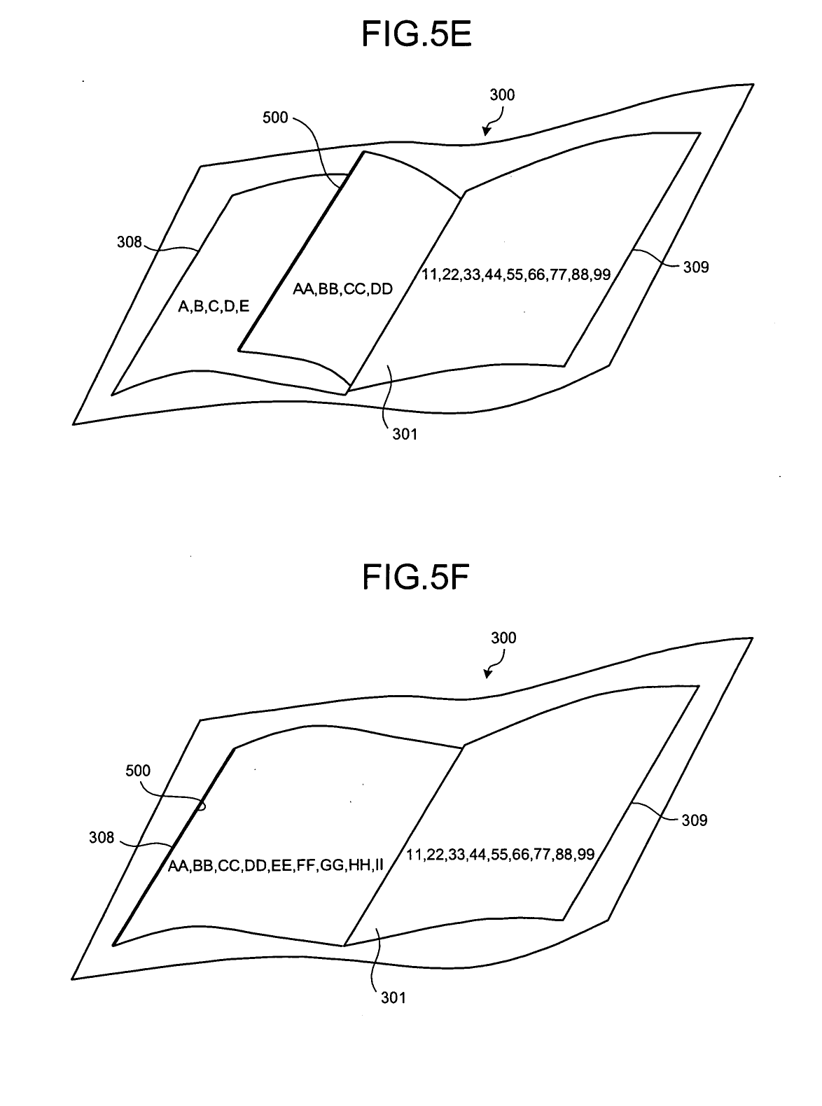

FIGS. 5A to 5F are schematics for illustrating changes in a page-turn operation. As shown in FIG. 5A, of the left and right pages currently displayed on the display unit 301, “1, 2, 3, 4, 5, 6, 7, 8, 9” is displayed in a horizontal row on the right page, and “A, B, C, D, E, F, G, H, I” is displayed in a horizontal row on the left page. After turning the right page once, “11, 22, 33, 44, 55, 66, 77, 88, 99” is displayed in a horizontal row on the next right page, and “AA, BB, CC, DD, EE, FF, GG, HH, II” is displayed in a horizontal row on the next left page. Before turning the page, a boundary line 500 is positioned on a right page edge 309 of the display unit 301. Since there is no display unit 301 on the right side of the boundary line 500, nothing is displayed there, and the display contents of the right page and the left page currently displayed, respectively “1, 2, 3, 4, 5, 6, 7, 8, 9” and “A, B, C, D, E, F, G, H, I”, are all displayed on the left side of the boundary line 500.

When the right page in FIG. 5B starts to turn, the boundary line 500 moves leftward from the right page 309 to between the center of the display unit 301 and the right page 309. At this time, the display content “99” of the right edge section of the right page when one page is turned is displayed on the right side of the boundary line 500. On the left side, all the display content of the left page currently displayed, namely, “A, B, C, D, E, F, G, H, I” and the content of the right page currently displayed without the right edge section, namely, “1, 2, 3, 4, 5, 6, 7, 8”, are displayed.

As the boundary line 500 moves to the left, the display range of the right edge section of the next page increases toward the left. The display content displayed only as “99” in FIG. 5B gradually displays the display content on the left side of 99, and the display range of the left side of the next page increases according to the position of the boundary line 500 to, for example, “66, 77, 88, 99”. When the page is turned further and the boundary line 500 moves to the left, the display content changes to “44, 55, 66, 77, 88, 99” as shown in FIG. 5C. Meanwhile, the display range of the right page currently displayed decreases from the right and switches from “1, 2, 3, 4, 5, 6, 7, 8” to “1, 2, 3, 4, 5”. As the page turns further and the boundary line 500 moves to the left, the display content changes to “1, 2, 3” as shown in FIG. 5C.

As shown in FIG. 5D, when the right page is then turned, the boundary line 500 moves further to the left and becomes positioned in the center of the display unit 301. All the display contents of the next right page after the page-turn, namely, “11, 22, 33, 44, 55, 66, 77, 88, 99”, are now displayed on the right side of the boundary line 500. On the left side, all the display content of the right page currently displayed are no longer displayed, while all the display contents of the left page, namely, “A, B, C, D, E, F, G, H, I” are displayed.

When the right page is turned further, the boundary line 500 of FIG. 5E moves to the left and becomes positioned between the center of the display unit 301 and a left page edge 308. The left and right display contents of the next page are now displayed on the right side of the boundary line 500. Specifically, the display content of the next right page after the page-turn, namely, “11, 22, 33, 44, 55, 66, 77, 88, 99” is displayed in the right page portion on the right side of the boundary line 500. The display content of the left portion of the next left page after the page-turn, namely, “AA, BB, CC, DD” is displayed in the left portion on the right side of the boundary line 500. The display content of the right portion of the left page currently displayed, namely, “A, B, C, D, E”, is displayed on the left side of the boundary line 500.

As the boundary line 500 moves to the left, the display range of the right portion of the next right page displayed on the right side of the boundary line 500 increases toward the left, changing from “AA” to “AA, BB”. When the page is turned further and the boundary line 500 moves to the left, the display content changes to “AA, BB, CC, DD, EE, FF, GG, HH”. Meanwhile, the display range of the left page currently displayed on the left side of the boundary line 500 decreases, and the display content changes from “A, B, C, D, E, F, G, H” to “A, B, C, D, E, F”. As the page is turned further and the boundary line 500 moves further to the right, the display content changes to “A, B, C”.

As shown in FIG. 5F, when the right page is finished, the boundary line 500 moves to the left page 308 of the display unit 301. At this time, the display content of the next right page after the page-turn, namely, “11, 22, 33, 44, 55, 66, 77, 88, 99” and the display content of the left page, namely, “AA, BB, CC, DD, EE, FF, GG, HH, II” are all displayed on the right side of the boundary line 500. Since no part of the display unit 301 remains on the left side of the boundary line 500, nothing is displayed there. Therefore, all the display contents of the display unit 301 are switched and the page-turn is complete.

While the above example describes a display contents of a page-turn when the spread-open status includes two pages (left and right), even if the spread-open status includes one page, the display content of the next page after a page-turn visible on the right side of the boundary line 500 can be displayed as if pages are leafed through by moving the boundary line 500. In a display unit 301 whose spread-open status includes one page, when the boundary line 500 moves as the page is turned, the next one-page when one page is turned is displayed from the right edge on the right side of the boundary line 500. On the left side of the boundary line 500, the display range of the page currently displayed is sequentially reduced from the right edge as the display content is displayed.

When the boundary line 500 moves to the left side of the center of the display unit 301, the display content in the left edge portion of the display range on the right side of the boundary line 500 differs from that when the spread-open status includes two pages (left and right) in that it displays the rear side of the page currently displayed. Therefore, when the rear side is blank, the display content is displayed as a blank page.

The electronic book 300 of this embodiment can achieve a display that appears as if pages are leafed through by repeatedly switching the display contents by bending a predetermined detecting unit of the display unit 301 as described above. The electronic book 300 also controls the speed of the page-turn according to changes in the bend level. As the page-turn speed increases, the movement speed of the electronic book 300 increases and a plurality of boundary lines 500 are displayed on the display unit 301. Display contents of both sides of each boundary line correspond to the display position as mentioned above. The display control apparatus can display as if pages are leafed through, such as the display unit 301 shown in FIG. 4, by extracting the topmost page from the overlapping sequence of the pages of the display contents and by controlling the display contents.

General electronic books use display methods where, when a command is made to turn a page, the entire contents displayed on the display unit 301 are immediately switched to those of the next page, or the display contents are scrolled, and so on. In contrast, the electronic book 300 makes the display appear as if pages are leafed through, thereby visually remaining an image of the display contents of the previous page in a memory of the operator. This enables the user to visually confirm continuity between the previous and subsequent pages, and to rapidly ascertain the display contents in the same manner as an actual book.

By using a residual image, if the book data includes, for example, a number of pages in English followed by a page in Japanese, the change from English to Japanese can be confirmed from the continuity between previous and subsequent pages by leafing through of pages and rapid page-turns. This enables a desired page to be found quickly without using the index.

When turning a left page, the boundary line 500 between the page currently displayed and the page displayed next moves from the left page edge 308 toward the right until it finally reaches the position of the right page edge 309, completing the page-turn. Before turning a left page, the boundary line 500 is positioned at the left page edge 308. Since there is no display unit 301 on the right side of the boundary line 500, nothing is displayed there, and the display contents of the current page are all displayed on the left side of the boundary line 500.

When the boundary line 500 moves rightward from the left page edge 308 to a position between the center of the display unit 301 and the left page edge 308, the display contents in the left edge portion of the display contents of the next page are displayed on the left side of the boundary line 500. The display contents displayed on the right side of the boundary line 500 exclude the left edge portion of the current page. As the boundary line 500 moves to the right, the display range of the left edge portion of the next page increases rightward while the display range of the current page decreases from the left. When the boundary line 500 moves further to the right and reaches the center of the display unit 301, the display content of the left half of the display contents of the next page is displayed on the left side of the boundary line 500. The display content in the left half of the current page is displayed on the right side of the boundary line 500.

When the boundary line 500 moves further and reaches a position between the center of the display unit and the right page edge 309, the left half of the display contents of the next page are displayed in the left half of the left side of the boundary line 500. The display contents in the right edge portion of the next page are displayed in the right half of the left side of the boundary line 500. The display contents of the right edge of the current page are displayed on the right side of the boundary line 500. As the boundary line 500 moves rightward, the display range of the left edge portion of the next page increases toward the right and the display range of the right edge portion increases toward the left, while the display range of the current page decreases to the right.

When the boundary line 500 reaches the right page edge 309 of the electronic book 300, all the display contents of the next page are displayed on the left side of the boundary line 500 while nothing is displayed on the right side, since there is no display unit 301 remaining there. Therefore, all the display contents of the display unit 301 change and the page is completely turned.

While the page is turned left and right in this embodiment, pages of the electronic book 300 can also be turned up and down. When turning pages of the electronic book 300 up and down, the display unit 301 is rotated by 90 degree and the detecting units 302 to 307 set for upward and downward page-turns, or detecting units for upward and downward page-turns can be added to the display unit 301 while keeping it facing in the same direction.

Before turning a page, the boundary line is at the bottom edge of the display unit 301. Since there is no display unit 301 below the display unit 301, nothing is displayed there, and all the display contents of the current page are displayed above the boundary line.

When the boundary line moves upwards from the bottom edge and reaches a position between the center of the display unit 301 and its bottom edge, the display contents in the bottom edge portion of the next page are displayed below the boundary line. The “center” in this explanation of the upward page-turn operation is the position of a horizontal line that divides the top and bottom of the display unit 301. Above the boundary line, display contents excluding the bottom edge portion of the current page are displayed. As the boundary line moves upwards, the display range of the bottom edge portion of the next page increases upwards while the display range of the current page decreases from the bottom. When the boundary line moves further upwards and reaches the center of the display unit 301, the display contents of the bottom half of the next page is displayed below the boundary line. The display contents of the top half of the current page are displayed above the boundary line.

When the boundary line moves further and reaches a position between the center of the display unit and the top edge thereof, the display contents of the bottom half of the next page are displayed in the bottom half below the boundary line. The display contents in the top edge portion of the next page are displayed in the top half below the boundary line. The display contents of the top edge of the current page are displayed above the boundary line. As the boundary line moves upwards, the display range of the bottom portion of the next page increases at the top and the display range of the top edge portion increases at the bottom, while the display range of the current page decreases at the top.

When the boundary line reaches the top edge of the display unit 301, all the display contents of the next page are displayed below the boundary line while nothing is displayed above the line, since there is no display unit 301 remaining there. Therefore, all the display contents of the display unit 301 are switched and the page-turn is complete.

A downward page-turn and its display contents along the position of the boundary line are explained next. Before turning a page, the boundary line is at the top edge. Since there is no display unit 301 above the display unit 301, nothing is displayed there, and all the display contents of the current page are displayed below the boundary line.

When the boundary line moves downwards from the top edge and reaches a position between the center of the display unit 301 and its top edge, the display contents in the top edge portion of the next page are displayed above the boundary line. Display contents excluding the bottom edge portion of the current page are displayed below the boundary line. As the boundary line moves downwards, the display range of the top edge portion of the next page increases downwards while the display range of the current page decreases from the top. When the boundary line moves further downwards and reaches the center of the display unit 301, the display contents of the top half of the next page are displayed above the boundary line, and the display contents of the bottom half of the current page are displayed below the line.

When the boundary line moves further and reaches a position between the center of the display unit and the bottom edge thereof, the display contents of the top half of the next page are displayed in the top half above the boundary line. The display contents in the bottom edge portion of the next page are displayed in the bottom half above the boundary line. The display contents of the bottom edge of the current page are displayed below the boundary line. As the boundary line moves downwards, the display range of the top edge portion of the next page increases at the bottom and the display range of the bottom edge portion increases at the top, while the display range of the current page decreases at the bottom. When the boundary line reaches the bottom edge of the display unit 301, all the display contents of the next page are displayed above the boundary line while nothing is displayed below the line, since there is no display unit 301 remaining there. Therefore, all the display contents of the display unit 301 are switched and the page-turn is complete.

As described above, when a page is turned up and down, the display contents above and below the boundary line are switched and the display on the display unit 301 appears as if the page is leafed through. If the turning speed increases when turning a page up and down, a plurality of boundary lines are displayed and the display control apparatus displays only the display content on the uppermost portion.

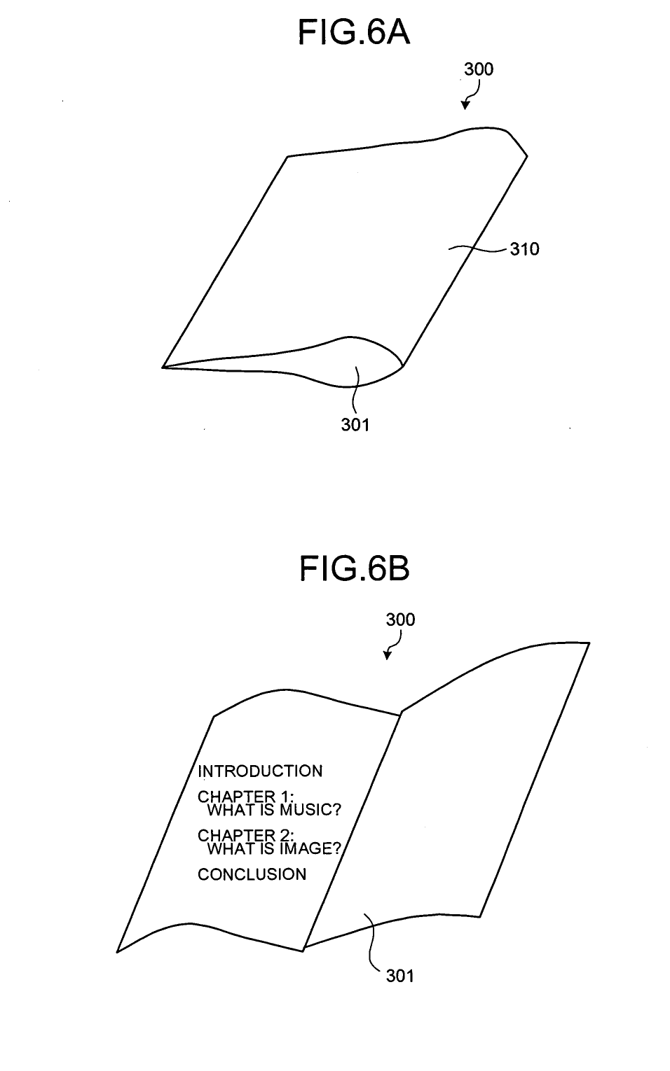

FIG. 6A is a schematic of an electronic book when its power is turned off. In FIG. 6A, a display unit 301 of an electronic book 300 is folded in two, the display unit 301 being folded inside so that an underside 310 of the display unit 301 becomes the outer side. This enables the electronic book 300 to be turned off, stopping the display of the display unit 301. This double-fold state can be detected as a state when left and right detecting units are joined, for example, the left top edge detecting unit 302 to the right top edge detecting unit 305, the left center edge detecting unit 303 to the right center edge detecting unit 306, and the left bottom edge detecting unit 304 to the right bottom edge detecting unit 307 (at this time, the surfaces of the flex sensors do not use a capacitance system, or their capacitance system has to be cancelled). Another method is to provide a flex sensor in the center of the display unit 301 and detect a double-fold state when the inward bend of this flex sensor is smaller than a threshold angle.

FIG. 6B is a schematic of a display unit when the power of an electronic book is switched from OFF to ON. When the display control apparatus of the electronic book 300, after detecting the OFF status as shown in FIG. 6A, detects that the electronic book 300 has been reopened as shown in FIG. 6B, the electronic book turns ON and the display unit 301 restarts to display. When switching to OFF is detected, the display content is normally recorded in a display content retaining unit of the display control apparatus. Therefore, when the electronic book turns ON again, the display unit 301 displays the recorded content in the retaining unit. However, when the settings are such that the previous display contents are not recorded and when obtained electronic book data is displayed for the first time, an index page shown in the display unit 301 of FIG. 6B is displayed.

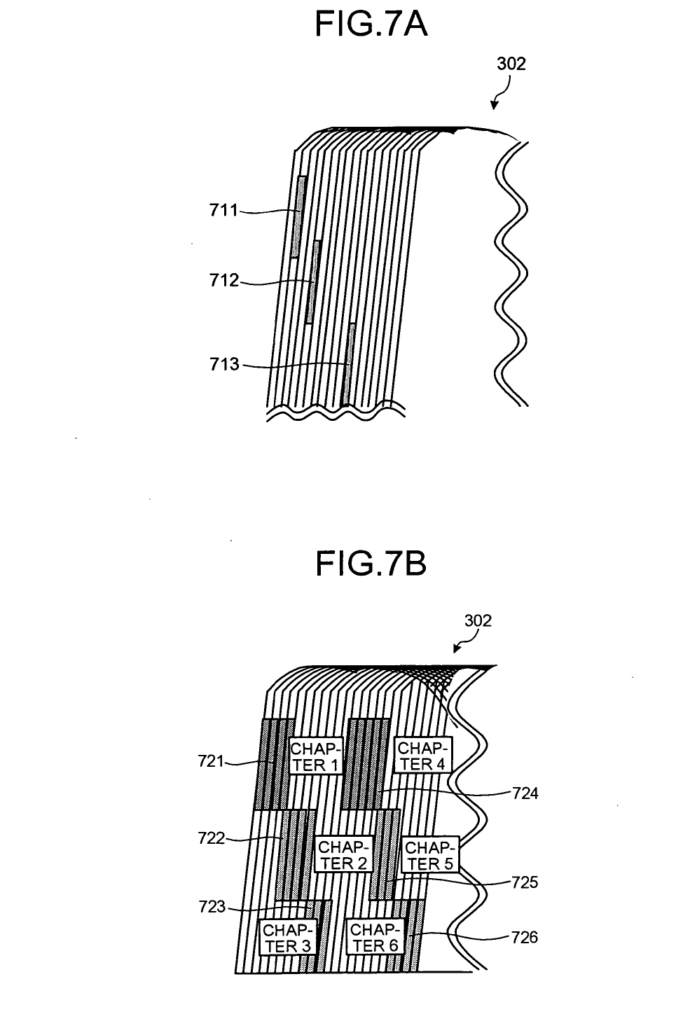

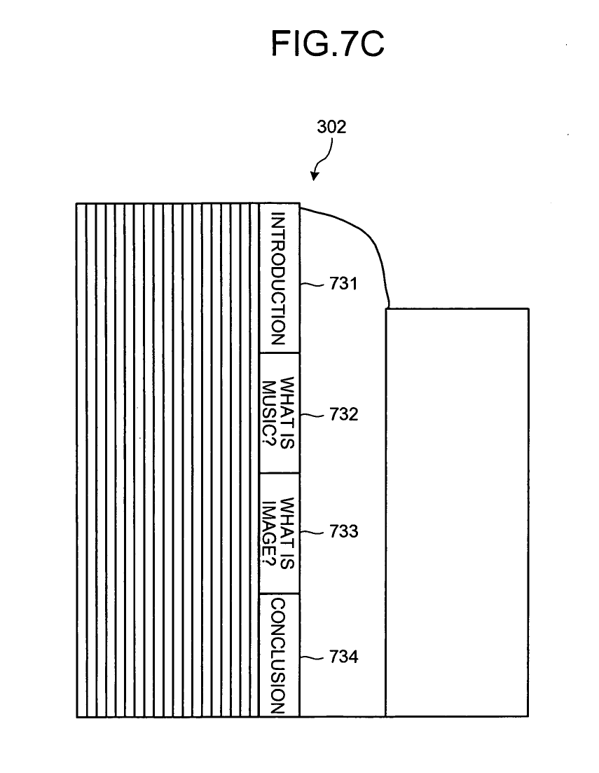

FIG. 7A is a schematic for illustrating a bookmark index displayed on a display unit of an electronic book. When the left top edge detecting unit 302 of FIG. 3A is largely bent, the display contents are switched and a bookmark index is displayed. A bookmark index displays indexes relating to pages behind the display contents currently being displayed (in the case of a electronic book data opening to the right), and displays indexes 711 to 713 that are added by the marking function described in FIG. 3A. When the left top edge detecting unit 302 is bent further, headings of specific display contents are displayed in bookmark portions of the indexes 711 to 713.

When the indexes 711 to 713 of FIG. 7A are bent, the display control apparatus switches the display such that pages corresponding to the indexes 711 to 713 are displayed. Similarly, when the right top edge detecting unit 305 is largely bent, an index relating to pages preceding the current display contents (in the case of an electronic book data opening to the right) is displayed.

FIG. 7B is a schematic for illustrating a chapter index displayed on a display unit of an electronic book. When the left top edge detecting unit 302 of FIG. 3A is largely bent, the display contents are switched and a chapter index is displayed. The chapter index displays indexes relating to each chapter of pages behind the display contents currently being displayed (in the case of a electronic book data opening to the right), and displays indexes 721 to 726 that are added by the marking function described in FIG. 3A. When the left top edge detecting unit 302 is bent further, headings of specific display contents are displayed in bookmark portions of the indexes 721 to 726.

The bookmark indexes and the chapter indexes are displayed when the detecting units detects a largely bending, and as to which index is displayed is determined by the number of bends. Therefore, the setting is such that the most frequently used index is displayed by the first bend. FIG. 7C is a schematic for illustrating another chapter indexes displayed on a display unit of a display control apparatus. Chapter indexes such as tabs 731 to 734 can be displayed instead of the chapter indexes shown in FIG. 7B. In still another display arrangement, contents like an index of an actual book can be displayed as shown in FIG. 6B.

By switching the display contents to the index in compliance with a predetermined process in this way, the display unit 301 can be used effectively. By displaying the index, it is possible to speedily turn to a desired page.

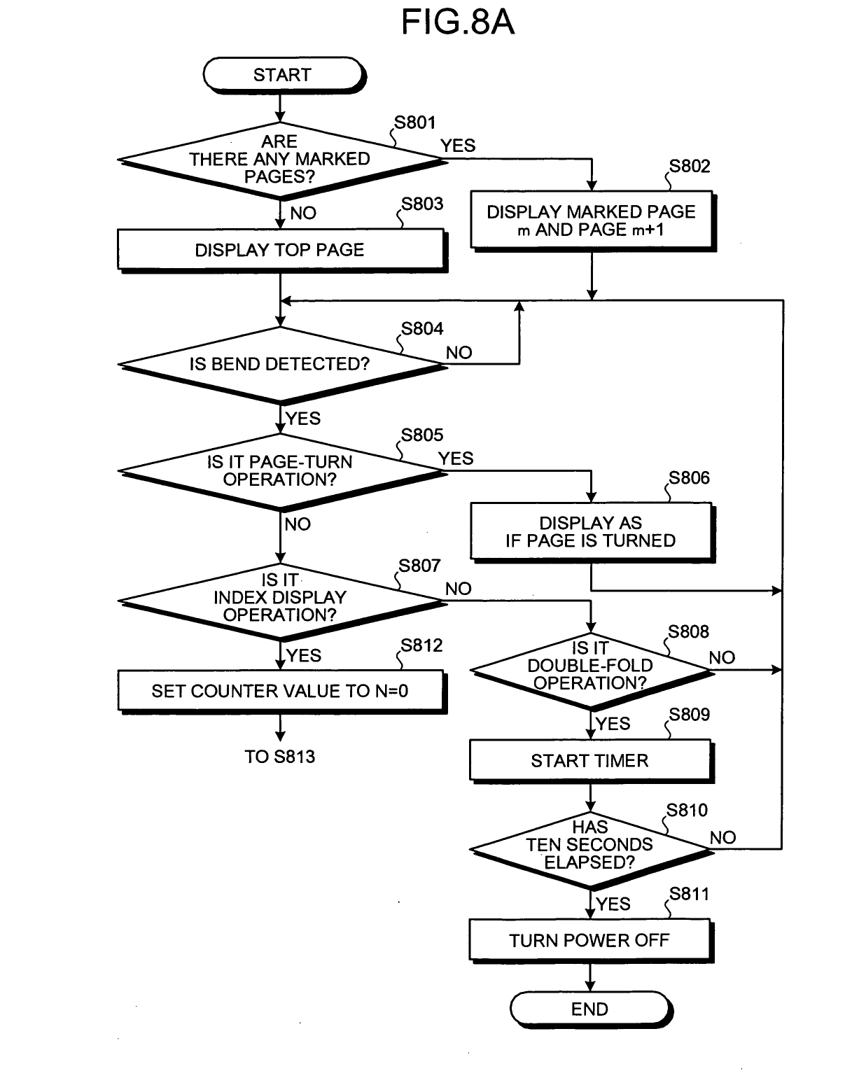

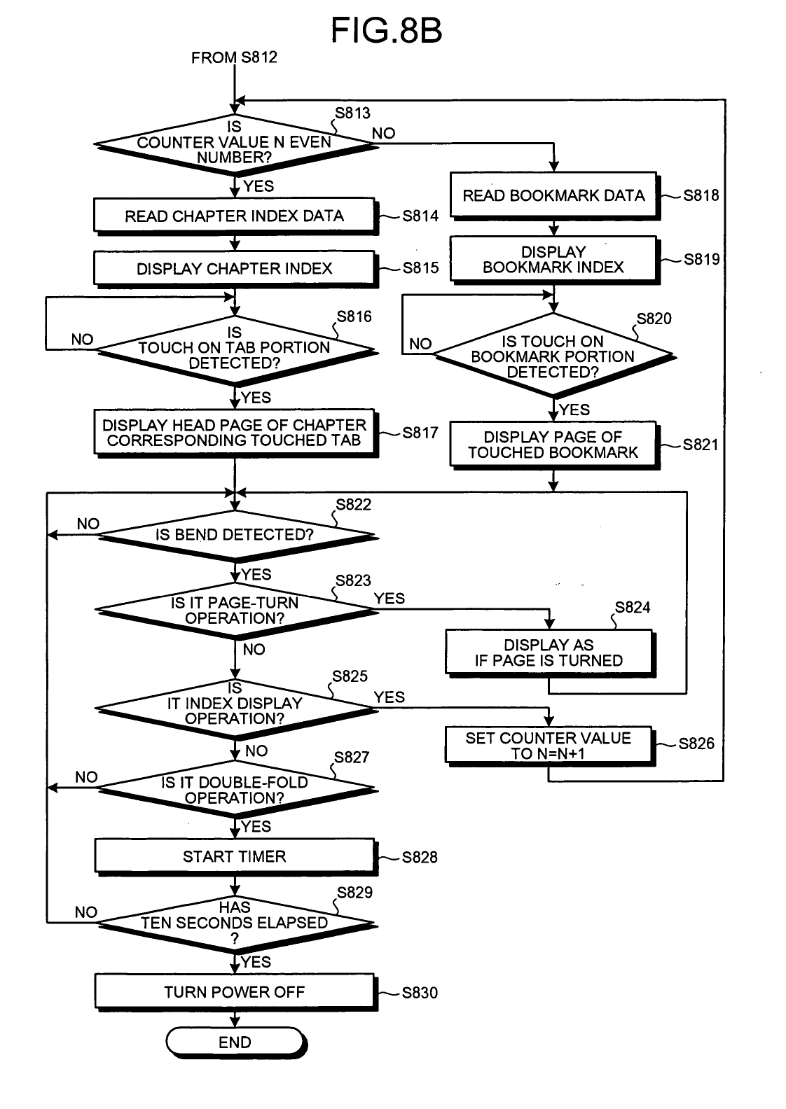

FIGS. 8A and 8B are flowcharts of display control procedures. These procedures are executed by a determining unit of the display control apparatus. It is determined whether there are bookmarks in the display content retaining unit of the display control apparatus (step S801). If there are bookmarks (step S801: YES), the latest marked pages, page m and page m+1, for example, are displayed on the display unit 301 (step S802) and the process shifts to step S804. The marking data of step S802 is an example of a spread-open display of pages (m and m+1) indicated by the latest (in terms of time) bookmark data.

When it is determined at step S801 that there is no mark (step S801: NO), a top page of the book data is displayed on the display unit 301 (step S803) and the process shifts to step S804. When making the basic settings, the top page of the book data displays a full listing of indexes such as that in FIG. 6B. Alternatively, the settings can be such that a page specified by the operator or display contents selected by the operator is displayed on the top page.

When the process of step S802 or step S803 ends, it is then determined whether one of the detecting units 302 to 307 has detected any bend (step S804). The determining unit waits in standby until a bend is detected (step S804: NO Loop) and, when one is detected (step S804: YES), the determining unit determines whether the detected bend is a page-turn operation (step S805).

If a page-turn operation is determined in step S805 (step S805: YES), the display contents of the book data are switched on the display unit 301 such that as if the page is being turned (step S806). For example, the method described in FIGS. 5A to 5F can be used to make it “appear as if the page is being turned”. When the process of step S806 ends, the determining unit returns to the process of step S804, and waits in standby until it detects a bend of one of the detecting units 302 to 307.

When it is determined in step S805 that the detected bend is not a page-turn operation (step S805: NO), it is determined whether the next detected bend is an index display operation (step S807). In step S807, if it is determined that the detected bend is not an index display operation (step S807: NO), it is then determined whether the detected bend is a double-fold operation (step S808).

When it is determined in step S808 that the detected bend is not a double-fold operation (step S808: NO), it is determined that the detected bend is not an operation for displaying the electronic book and the process returns to step S804, where the determining unit stands by until the next bend is detected. When it is determined in step S808 that the detected bend is a double-fold operation (step S808: YES), the determination of step S808 is used as a trigger for starting a timer (step S809). It is then determined whether a predetermined time (ten seconds in this embodiment) elapses on the timer started in step S809 (step S810).

If a new bend is detected before ten seconds elapse on the timer (step S810: NO), the process returns to step S804 and the operation content of the detected bend is determined again. When it is determined that ten seconds have elapsed since the timer started in step S809 (step S810: YES), the power of the electronic book is turned off (step S811) and the series of processes ends. Of course, the predetermined time is not limited to ten seconds and can be set arbitrarily by the operator or the manufacturer to a time shorter or longer than ten seconds.

Returning to the determination of step S807, a process when it is determined that the detected bend is an index display operation (step S807: YES) is explained. To display an index on the display unit 301 of the electronic book, a counter value N of the display content retaining unit is set to “0” (step S812). The process then returns to the flowchart of FIG. 8B, and it is determined whether the counter value N is an even number (step S813).

When it is determined that the counter value N is an even number (step S813: YES), chapter index data is read from the book data (step S814) and a chapter index is displayed on the display unit 301 (step S815). A chapter index displays the book data of the electronic book separately for each chapter of the pages, as shown in FIG. 7B.

It is then determined whether a touch on the tab portions of the chapter index displayed on the display unit 301 (tabs 721 to 726 shown in FIG. 7B) is detected (step S816). The determining unit stands by until a tab portion is touched (step S816: NO) and, when a touch is detected (step S816: YES), a head page of the chapter corresponding to the touched tab detected in step S816 is displayed (step S817), and the process shifts to step S822.

On the other hand, if the counter value N is determined to be an odd number in step S813 (step S813: NO), bookmark data is read from the display content retaining unit of the book data (step S818), and a bookmark index is displayed on the display unit 301 (step S819). As shown in FIG. 7A, this bookmark data displays the indexes stored in the display content retaining unit 104 corresponding to the pages when the operator makes a command to mark a specific page.

It is then determined whether a touch on the bookmark portions of the bookmark indexes displayed on the display unit 301 (tabs 711 to 713 in FIG. 7A) is detected (step S820). The determining unit waits in standby until a bookmark portion is touched (step S820: NO) and, when a touch is detected (step S820: YES), a bookmark page corresponding to the touched portion detected in step S820 is displayed (step S821) on the display unit 301, and the process shifts to step S822.

When the processes of steps S817 and S821 ends, it is determined again whether a bend is detected (step S822). The determining unit stands by until a bend is detected (step S822: NO) and, when a bend is detected (step S822: YES), determines whether the detected bend is a page-turn operation (step S823). If it is determined that a page-turn operation has been performed (step S823: YES), the display contents of the book data are switched on the display unit 301 such that as if the page is being turned (step S824). In step S824, the process to make it “appear as if the page is being turned” is the same as that of step S806. When the process of step S824 ends, the determining unit returns to the process of step S822, and waits in standby until it detects a bend of one of the detecting units 302 to 307.

On the other hand, when it is determined that the detected bend is not a page-turn operation (step S823: NO), it is then determined whether the next detected bend is an index display operation (step S825). When it is determined that the detected bend is an index display operation (step S825: YES), the counter value N is incremented by “+1” (step S826), and the process returns to step S813 where it is determined whether the counter value is an even number. That is, the chapter indexes and the bookmark indexes can be alternately switched and displayed on the display unit 301 by repeating the index display operation.

Returning to step S825, when it is determined that the detected bend is not an index display operation (step S825: NO), it is then determined whether the detected bend is a double-fold operation (step S827). When it is determined that the detected bend is not a double-fold operation (step S827: NO), the process returns to step S822 and waits in standby until another bend is detected.

When it is determined that the detected bend is a double-fold operation (step S827: YES), the determination of step S827 is used as a trigger for starting a timer (step S828). It is then determined whether ten seconds elapses on the timer started in step S828 (step S829).

If a new bend is detected before ten seconds elapse on the timer (step S829: NO), the process returns to step S822 and the operation content of the detected bend is determined again. When it is determined in step S829 that ten seconds have elapsed since the timer started in step S828 (step S829: YES), the power of the electronic book is turned off (step S830) and this series of processes ends.

As described above, according to the display control apparatus, the display method, the display program, and the recording medium according to the present invention, a desired page can be speedily displayed by an operation similar to that for an actual book.

In still another embodiment, when the display unit 301 of the electronic book 300 is folded in two to the outside, the right half or the left half of the display unit 301 is displayed while not displaying the other half. When using this method, the display control apparatus detects that the size of the display unit 301 has halved, and halves the size of the display contents to be displayed. The positions of the detecting units 302 to 307 shown in FIG. 3A can also be changed according to the size reduction of the display unit 301. This enables the electronic book 300 to be used in a congested place such as a crowded train without concern for the surroundings.

In still another embodiment, when the display unit 301 of the electronic book 300 is folded in two to the outside, identical display contents can be reduced to half-size and displayed in the left half portion and the right half portion. This enables the electronic book 300 to be viewed simultaneously by many people.

The display method explained in the embodiments can be realized by making a computer, such as a personal computer and a work station, execute a program that is prepared beforehand. The program is stored in a computer-readable recording medium, such as a hard disk, a flexible disk, a compact-disc read-only memory, a magneto optical disk, a digital versatile disk, and the like, and is executed by being read from the recording medium by the computer. The program can be a transmission medium that can be distributed via a network such as the Internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2005-299355 filed in Japan on Oct. 13, 2005.

What is claimed is:

1. A display control apparatus, comprising:
a detecting unit configured to detect a bend of a flexible display;
a determining unit configured to determine a display command based on the detected bend; and
a control unit configured to control to display an image of turning pages sequentially turned based on the display command.

2. The display control apparatus according to claim 1, wherein
the detecting unit is configured to detect a bend at an edge of the flexible display; and
the control unit is configured to switch to display an index of contents, when the detecting unit detects a bend at the edge.

3. The display control apparatus according to claim 2, wherein
the detecting unit is configured to detect a predetermined bend of the flexible display; and
the control unit is configured to mark a display content being displayed on the flexible display when the detecting unit detects the predetermined bend, and to add the marked display content to the index.

4. The display control apparatus according to claim 1, wherein
the detecting unit is configured to detect a folded state in which the flexible display is folded, and a reopened state in which the flexible display is reopened after once being in the folded state, and
the control unit is configured to stop display on the flexible display when the detecting unit detects the folded state, and to restart the display when the detecting unit detects the reopened state.

5. The display control apparatus according to claim 1, further comprising a retaining unit configured to retain a display content on the flexible display; wherein
the detecting unit is configured to detect a folded state in which the flexible display is folded and a reopened state in which the flexible display is reopened after once being in the folded state, and
the control unit is configured to retain a display content, when the detecting unit detects the folded state, the display content being displayed at a time of detection of the folded state, and to display retained display content on the flexible display when the detecting unit detects the reopened state.

6. A display method of a flexible display, comprising:
detecting a bend of a flexible display;
determining a display command based on the detected bend; and
controlling to display an image of turning pages sequentially turned based on the display command.

7. The display method according to claim 6, wherein
the detecting includes detecting a bend at an edge of the flexible display; and
the controlling includes controlling the flexible display to switch to display, when the bend is detected at the edge, an index of contents.

8. The display method according to claim 7, wherein
the detecting includes detecting a predetermined bend of the flexible display; and
the controlling includes controlling the flexible display to mark a display content being displayed on the flexible display, when the predetermined bend is detected at the detecting, and to add the marked display content to the index.

9. The display method according to claim 6, wherein
the detecting includes detecting a folded state in which the flexible display is folded, and a reopened state in which the flexible display is reopened after once being in the folded state, and
the controlling includes controlling the flexible display to stop display when the folded state is detected at the detecting, and to restart the display when the reopened state is detected the detecting.

10. The display method according to claim 6, further comprising retaining a display content on the flexible display; wherein
the detecting includes detecting a folded state in which the flexible display is folded and a reopened state in which the flexible display is reopened after once being in the folded state, and
the controlling includes controlling the flexible display to retain a display content, when the folded state is detected at the detecting, the display content being displayed at a time of detection of the folded state, and to display retained display content when the reopened state is detected at the detecting.

11. A computer-readable recording medium that stores therein a computer program for realizing a display method of a flexible display, the computer program making a computer execute:
detecting a bend of a flexible display;
determining a display command based on the detected bend; and
controlling to display an image of turning pages sequentially turned based on the display command.

12. The computer-readable recording medium according to claim 11, wherein
the detecting includes detecting a bend at an edge of the flexible display; and
the controlling includes controlling the flexible display to switch to display an index of contents, when the bend is detected at the edge.

13. The computer-readable recording medium according to claim 12, wherein
the detecting includes detecting a predetermined bend of the flexible display; and
the controlling includes controlling the flexible display to mark a display content being displayed on the flexible display, when the predetermined bend is detected at the detecting, and to add the marked display content to the index.

14. The computer-readable recording medium according to claim 11, wherein
the detecting includes detecting a folded state in which the flexible display is folded, and a reopened state in which the flexible display is reopened after once being in the folded state, and
the controlling includes controlling the flexible display to stop display when the folded state is detected at the detecting, and to restart the display when the reopened state is detected the detecting.

15. The computer-readable recording medium according to claim 11, further comprising retaining a display content on the flexible display; wherein
the detecting includes detecting a folded state in which the flexible display is folded and a reopened state in which the flexible display is reopened after once being in the folded state, and
the controlling includes controlling the flexible display to retain a display content, when the folded state is detected at the detecting, the display content being displayed at a time of detection of the folded state, and to display retained display content when the reopened state is detected at the detecting.

16. A display control apparatus, comprising:
a detecting unit configured to detect a flexure of a flexible display;
a determining unit configured to determine whether the flexure has a first pattern;
a command generating unit configured to generate a first display control signal to control video data to be displayed on the flexible display, wherein
the first display control signal is generated when the determining unit determines that the flexure has the first pattern.

17. The display control apparatus according to claim 16, wherein
the determining unit is configured to further determine whether the flexure has a second pattern that is different from the first pattern,
the command generating unit is configured to generate a second display control signal when the determining unit determines that the flexure is the second pattern, and
the video date includes content index information, if the flexure is a second predetermined flexure.

18. The display control apparatus according to claim 16, wherein the first predetermined flexure is a flexure in which the flexible display is bent on a whole area thereof.

19. The display control apparatus according to claim 17, wherein the second predetermined flexure is a flexure in which the flexible display is partially bent on an edge area thereof.
